(19) United States
(12) Patent Application Publication
(10) Pub. No.: US 2025/0106708 A1
(43) Pub. Date: Mar. 27, 2025

(54) LOWER LAYER RACH-LESS INTER-CELL MOBILITY

(71) Applicant: Nokia Technologies Oy, Espoo (FI)

(72) Inventors: Ahmad AWADA, Munich (DE); Srinivasan SELVAGANAPATHY, Bangalore (IN); Subramanya CHANDRASHEKAR, Bangalore (IN); Alperen GUNDOGAN, Munich (DE); Panagiotis SPAPIS, Munich (DE); Amaanat ALI, Espoo (FI)

(21) Appl. No.: 18/713,510

(22) PCT Filed: Dec. 16, 2022
(86) PCT No.: PCT/EP2022/086417

§ 371 Date: May 24, 2024

(30) Foreign Application Priority Data
Dec. 20, 2021 (IN) 202141059410

(51) Int. Cl. H04W 36/00; H04L 5/00

(52) U.S. Cl. CPC H04W 36/00725; H04L 5/0044

(57) ABSTRACT

In this invention, when a serving distributed unit informs target distributed unit via a central unit about a target reference, it is proposed to use, signal index X/indices X1 . . . Xn for PDCCH transmissions or PUSCH receptions or a RACH-less handover:

Send by a distributed unit of the serving cell towards a distributed unit of a target cell one of before, upon, or after transmission of a layer 1 serving cell change command to a user equipment, signaling comprising configuration information associated with the user equipment to perform a random access channel less handover of the user equipment to the target cell, wherein the configuration information informs the target cell about at least one target reference signal index that shall be used for at least one of at least one physical downlink control channel transmission or at least one physical uplink shared channel reception.

### TECHNICAL FIELD

The teachings in accordance with the exemplary embodiments of this invention relate generally to RACH-less handover operations and, more specifically, relate to RACH-less handover operations including where a serving distributed unit informs target distributed unit via a central unit about a target reference signal index X/indices X1 . . . Xn that shall be used for PDCCH transmission or PUSCH reception.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
ACK acknowledgement
CSI-RS channel state information-reference signal
CU centralized unit
DU distributed unit
DL downlink
EN-DC evolved-universal terrestrial radio access-new radio
gNB base station
HO handover
L1 layer 1
L2 layer 2
LTE long term evolution
MAC medium access control
MAC CE medium access control-control element
NG next generation
NR new radio
PDCCH physical downlink control channel
PUSCH physical uplink shared channel
RAN random access network
RRC radio resource control
RS reference signal
RSRP reference signal received power
SSB synchronization signal block
QCL quasi co-location
RACH random access channel
TCI transmission configuration indication
TTT time to trigger
UE user equipment
UL uplink

Fifth generation mobile networks must address substantial growth of traffic load, connected devices, and provide reliability and also reduce latency. Particularly, mobility such as via handovers is essential for achieving low handover latency. However, current networks can require synchronous base stations for handovers based on random access which can add latency. To try to address this RACH-less handover operations have been introduced.

The RACH-less handover operations offer significant reductions in the data connectivity interruption time at each handover, no need for random access in the target cell, and reduced overall handover execution time.

Example embodiments of the invention work to improve handover mechanisms with new operations for RACH-less handover schemes.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows an exemplary signalling diagram for L1/2 inter-cell mobility;

FIG. 2 shows a signalling diagram for Option 1;

FIG. 3 shows a signalling diagram for Option 2;

FIG. 4 shows signalling diagram for Method 1 in accordance with example embodiments of the invention;

FIG. 5 shows a signalling diagram for the enhancements of Method 1 in accordance with example embodiments of the invention for improving reliability of PDCCH reception;

FIG. 6 shows a signalling diagram for Method 2 in accordance with example embodiments of the invention;

FIG. 7 shows a high level block diagram of various devices used in carrying out various aspects of the invention

FIG. 8A, FIG. 8B, and FIG. 8C each shows a method in accordance with example embodiments of the invention which may be performed by an apparatus.

### DETAILED DESCRIPTION

In this invention, there is proposed for a RACH-less handover operations including where a serving distributed unit informs target distributed unit via a central unit about a target reference signal index X/indices X1 . . . Xn that shall be used for PDCCH transmissions or PUSCH receptions.

Example embodiments of the invention as disclosed herein relates to L1/2 inter-cell mobility, which is one of the upcoming objectives for mobility enhancement at the time of this application. In contrast to L3 mobility procedures where the handover between two cells is decided by RRC layer, L1/2 inter-cell mobility is performed by the MAC layer terminated in the Distributed Unit.

In the example embodiments of the invention there is a focus on executing the cell change for L1/2 inter-cell mobility in a RACH-less manner. RACH-less handover was designed with LTE Rel-14. Its main goal was to decrease the interruption encountered by the UE during handover by skipping the first two steps of the Random-Access procedure.

In this application there is provided first an overview of L1/2 inter-cell mobility. Then, there is review RACH-less handover procedure which is specified in LTE and discussed for NR in Rel. 16 and TCI states that are used in beam management (beam switching).

### L1/2 Inter-Cell Mobility

L1/2 inter-cell mobility is one of the upcoming objectives for mobility enhancement in Rel. 18. In contrast to L3 mobility procedures where the handover between two cells is decided by RRC layer, L1/2 inter-cell mobility is performed by the MAC layer terminated in the Distributed Unit (DU).

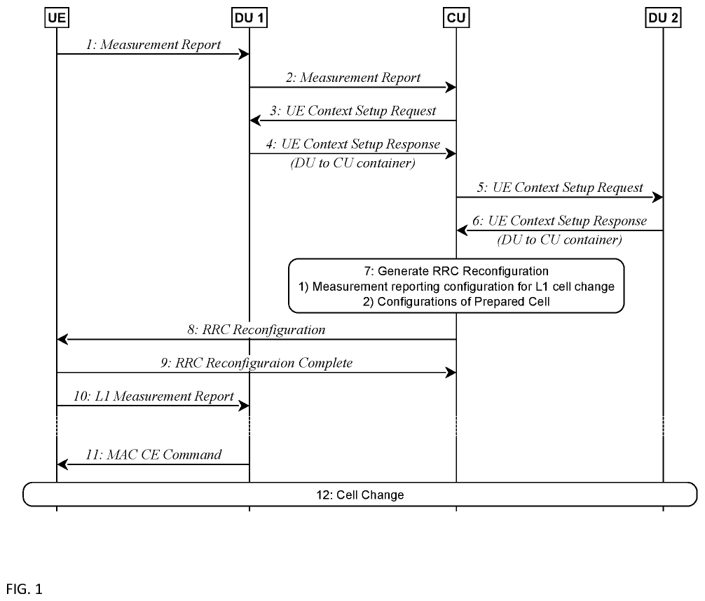

FIG. 1 shows on exemplary implementation for the signaling diagram of L1/2 inter-cell mobility from a serving cell in DU1 to a target cell in DU2 (inter-DU intra-CU scenario). The same diagram would apply as well in case of intra-DU intra-CU cell change where DU 1 would be the same as DU2.

There are two options for RACH-less HO to obtain an UL grant when applied to L1/2 inter-cell mobility:
Periodic UL grants provided at the time of handover preparation, and
Monitoring PDCCH transmission (scheduling an UL grant) from Target Cell.

Both options have shortcomings when applied to L1/2 inter-cell mobility.

Some main steps of L1/2 inter-cell mobility are summarized in the following:
In step 1, the UE sends measurement report containing the cell quality measurements of serving and neighboring cells. The UE can be configured by the serving cell to send measurement report early when it still has a good connection to the serving cell;
Using the reported cell quality measurements, the CU can identify a potential set of candidate target cells to which the UE can be handed over to. In this example, the CU identifies candidate target cells that are served by DU1 (controlling the serving DU/cell as well) and another DU2 that is controlled by the same CU;
In step 3, the CU requests the preparation of a candidate target cell in DU1 by sending UE Context Setup Request message to create a UE context and setup one or more data bearers. This message includes a HandoverPreparationInformation IE;
In step 4, DU1 provides the configuration of the UE in UE Context Setup Response message containing a container from DU to CU.
The same steps 5/6 are performed with respect to DU2 in order to prepare target cell(s) that are controlled by DU2;
Having received the UE configurations in the candidate target cell, the CU generates an RRC Reconfiguration that is sent to the UE in step 8. Among other information, the RRC Reconfiguration message contains:
   Measurement reporting configuration for L1/2 handover, i.e., configuration on how to report the L1 beam measurements of serving and target cells in step 10, and
   Configuration of the prepared candidate cell which the UE needs to execute when it receives a MAC CE command to change the serving cell (perform handover) as shown in step 11;
After confirming the RRC Reconfiguration message to the network in step 9, the UE starts to report periodically the L1 beam measurements of serving and candidate target cells as shown in step 10;
Upon determining that there is a target candidate cell having a better radio link beam measurement than the serving cell, e.g., L1-RSRP of target beam measurement>L1-RSRP of serving beam measurement+Off for e.g., Time-to-Trigger (TTT) time, the serving cell sends a MAC Control Element (MAC CE) or a L1 message to trigger the cell change to the target candidate cell in step 11; and/or
The handover from serving cell to target cell is executed by the UE in step 12.

Further, it is noted that 3GPP definitions for components pertaining to this application can include:
gNB Central Unit (gNB-CU): a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU;
gNB Distributed Unit (gNB-DU): a logical node hosting RLC, MAC and PHY layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU;
gNB-CU-Control Plane (gNB-CU-CP): a logical node hosting the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU; and
gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU;

RACH-less HO has been discussed for NR beamformed system at the time of this application but was not specified. Now at the time of this application mobility enhancement is re-considered for L1/2 inter-cell mobility.

It is noted that the term en-gNB is for a node providing NR user plane and control plane protocol terminations towards the UE, and acting as Secondary Node in EN-DC. In addition, that a gNB is a node or base station providing NR user plane and control plane protocol terminations towards the UE, and connected via the NG interface to the 5GC.

### RACH-less Handover

RACH-less handover (HO) was designed as a part of LTE Rel-14 [TS 36.300]. Its main goal was to decrease the interruption encountered by the UE during handover by skipping the first two steps of the Random-Access procedure (transmission of RACH preamble and receiving RACH Response (RAR)) and sending RRC Reconfiguration Complete directly after the reception of the handover command from the network. In order to make it possible, the following challenges had to be addressed (all applicable for the target cell):
How to obtain the UL grant for PUSCH?,
How to estimate the Timing Advance (TA)?, or
How to set the initial UL Tx power?

The LTE Rel-14 RACH-less HO solution addressed these issues as follows:
UL grant for PUSCH: Either UE receives in 1) a semi-persistent PUSCH grant as part of the HO command configuration (Option 1), or 2) in case the PUSCH grant was not provided via RRC Connection Reconfiguration in the source cell the UE directly obtains the UL grant by decoding the target cell's PDCCH (Option 2),
TA estimation: Other means to estimate Timing Advance (TA) have been the most problematic part and it was concluded RACH-less may be applied only when source cell's TA can be reused (i.e., target cell's TA=source cell's TA) or when TA=0 can be used (for example small cells), and
UL Tx power: UE does regular open loop Power control (PC) towards the target cell, and afterwards can follow the closed loop PC commands received via PDCCH. Hence, the power ramping step is ignored so the initial UL transmit power (Tx) power may be not very accurate.

RACH-less HO has been discussed for NR beamformed system in Rel. 16 but was not specified. Herein, Quasi-co Location (QCL) information of the PUSCH grant has been discussed for Option 1. For instance, a PUSCH grant is QCL with a specific RS index (SSB or CSI-RS) if the transmission of RS index (from network side) shares the same channel properties (doppler shift, doppler spread, average delay, delay spread, spatial RX parameter) as the received signal (payload) on PUSCH grant. Similarly, for Option 2, a PDCCH transmission from a (target) cell is QCL with a specific RS (SSB or CSI-RS) if the reception of RS index (from UE side) shares the same channel properties as the reception of PDCCH signal.

### TCI States and Beam Switching

TCI states defines the Quasi Co-Location (QCL) information for receiving the PDCCH or PDSCH signal. In particular, TCI state indicates for the UE the RS index (SSB index or CSI-RS index) for which the channel information(s) (doppler shift, doppler spread, average delay, delay spread, spatial RX parameter) apply for receiving PDCCH or PDSCH signals. The TCI states are configured to the UE by CU using an RRC Reconfiguration message. For triggering a beam switch within the same cell, the MAC layer of the serving base station updates the TCI-state ID (which is associated with a particular RS index). For instance, if the UE was using the QCL information of SSB index 1 (associated with TCI state ID 1) to receive/transmit (to the serving cell), the UE needs to start using QCL information of for example SSB index 2 (associated with TCI state 2) if the MAC CE sent by the DU contains TCI State ID 2.

In standards at the time of this application for mobility enhancement RACH-less execution of cell change is re-considered for L1/2 inter-cell mobility. Example embodiments of the invention focus on executing the cell change for L1/2 inter-cell mobility (step 11 of FIG. 1) in a RACH-less manner.

Here, there are explained issues that are associated with the two LTE options for obtaining an UL grant when applied to L1/2 inter-cell mobility.

### Option 1: Periodic UL Grants Provided at the Time of Handover Preparation

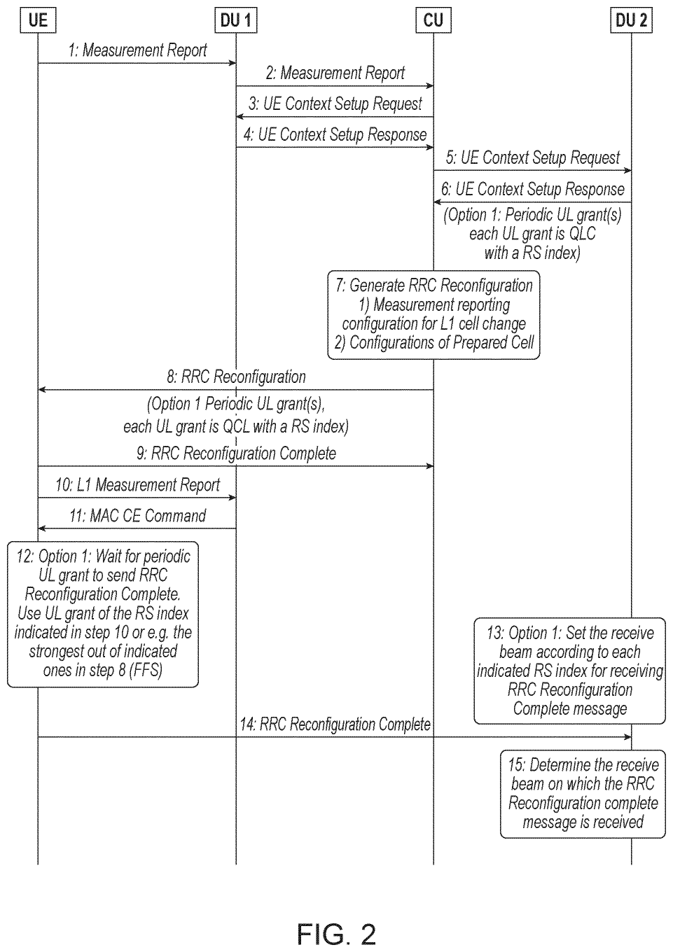

The signaling diagram for Option 1 is shown in FIG. 2.

The relevant steps of FIG. 2 are described in the following:
In step 6, the candidate target cell provides at least one periodic UL grant that is QCL with a RS index. The UL grants are provided to the UE in step 8 by the CU;
In step 11, DU1 controlling the serving cell triggers the cell change using a lower layer MAC CE or L1 message;
In step 12, UE uses of the periodic UL grant to send RRC Reconfiguration Complete message to the target cell indicating the completion of handover execution:
   The UE may use the periodic UL grant corresponding to the RS index that is indicated by DU1 in step 11, or
   The UE may use the periodic UL grant corresponding to the RS index having the highest L1 beam measurement at the time of sending RRC Reconfiguration Complete message;
In step 13, the target cell set the receive beam according to each indicated RS index in step 6 for receiving RRC Reconfiguration Complete message from the UE; and
When receiving RRC Reconfiguration Complete on one of the UL grants that are indicated to the UE, the target cell determines the receive/transmit beam which it shall use to communicate with the UE.

The disadvantages of this approach are summarized in the following:
As the preparation phase in L1/2 inter-cell mobility is de-coupled and performed much earlier (step 3/4/5/6) than the execution phase (step 11 onwards), the target cell needs to reserve radio resources for periodic UL grant for a long time; and.
Moreover, as the preparation is done early, the DU (DU2 in FIG. 2) cannot determine accurately the proper set of RS indices which are QCL with the UL grants:
   Using the beam measurements that may be forwarded by the CU to the DU, the DU can provide UL grants for the RS indices with the strongest beam measurements. However, as the execution is done later, it may well happen that none of the UL grants are valid to be used for sending RRC Reconfiguration Complete, e.g., L1-RSRP of the RS indices associated with UL grant fall below a threshold (becomes weak). In this case, the UE will need to fallback to other procedures such as random access, and
   In another approach, the DU can prepare UL grants on all RS indices. Obviously, this solution is highly costly in terms of radio resource reservation.

### Option 2: Monitoring PDCCH Transmission (Scheduling an UL Grant) From Target Cell

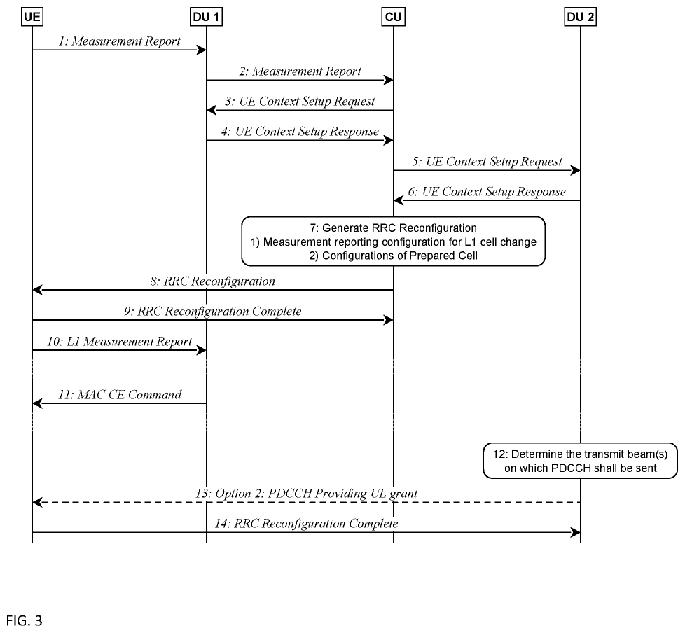

The signaling diagram for Option 2 is shown in FIG. 3.

In this option 2, the UE needs to monitor the PDCCH transmission from the target cell in step 13 to receive the UL grant for sending RRC Reconfiguration Complete message in step 14.

The issues with this approach are the following:
The target cell (controlled by DU2) does not know which DL beam (or the QCL information of which RS index) to use for sending the PDCCH in step 12, and
In addition, the target cell does not know when the cell change has been triggered to start the PDCCH transmission at all.

As such, both options 1 and 2 for RACH-less HO have shortcomings when applied to L1/2 inter-cell mobility.

To improve the handling example embodiments of this invention proposes two new methods:
1) The UE and target node of handover synchronizes on the QCL information for PDCCH transmission while ensuring that the target node:
   a. does not have to reserve radio resources for long time, and
   b. transmits the PDCCH only when the cell change has been triggered;
2) The target node activates the periodic UL grants for RACH-less HO only when the lower layer handover is triggered by the serving cell. This allows the target node to make overbooking of radio resources.

One target for example embodiments of the invention is for standards at the time of this application when L1/2 centric mobility will be defined.

A main novel step of example embodiments of the invention is that serving DU informs target DU via the CU about the target RS index X/indices X1 . . . Xn that shall be used for PDCCH transmission or PUSCH reception.

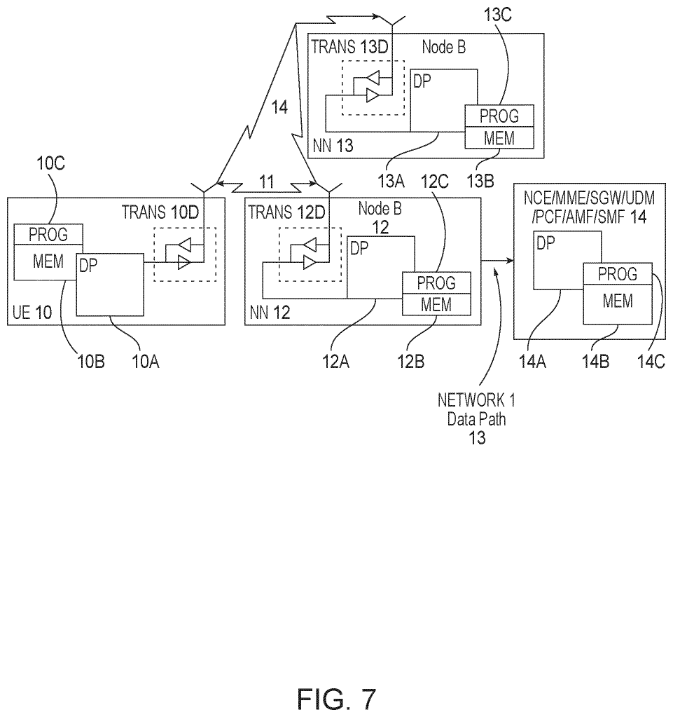

Before describing the example embodiments of the invention in detail, reference is made to FIG. 7 for illustrating a simplified block diagram of various electronic devices that are suitable for use in practicing the example embodiments of this invention.

FIG. 7 shows a block diagram of one possible and non-limiting exemplary system in which the example embodiments of the invention may be practiced. In FIG. 7, a user equipment (UE) 10 is in wireless communication with a wireless network 1 or network, 1 as in FIG. 7. The wireless network 1 or network 1 as in FIG. 7 can comprise a communication network such as a mobile network e.g., the mobile network 1 or first mobile network as disclosed herein. Any reference herein to a wireless network 1 as in FIG. 7 can be seen as a reference to any wireless network as disclosed herein. Further, the wireless network 1 as in FIG. 7 can also comprises hardwired features as may be required by a communication network. A UE is a wireless, typically mobile device that can access a wireless network. The UE, for example, may be a mobile phone (or called a “cellular” phone) and/or a computer with a mobile terminal function. For example, the UE or mobile terminal may also be a portable, pocket, handheld, computer-embedded or vehicle-mounted mobile device and performs a language signaling and/or data exchange with the RAN.

The UE 10 includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which can be optionally connected to one or more antennas for communication to NN 12 and NN 13, respectively. The one or more memories MEM 10B include computer program code PROG 10C. The UE 10 communicates with NN 12 and/or NN 13 via a wireless link 11.

The NN 12 (NR/5G Node B, an evolved NB, or LTE device) is a network node such as a master or secondary node base station (e.g., for NR or LTE long term evolution) that communicates with devices such as NN 13 and UE 10 of FIG. 7. The NN 12 provides access to wireless devices such as the UE 10 to the wireless network 1. The NN 12 includes one or more processors DP 12A, one or more memories MEM 12B, and one or more transceivers TRANS 12D interconnected through one or more buses. In accordance with the example embodiments these TRANS 12D can include X2 and/or Xn interfaces for use to perform the example embodiments of the invention. Each of the one or more transceivers TRANS 12D includes a receiver and a transmitter. The one or more transceivers TRANS 12D can be optionally connected to one or more antennas for communication over at least link 11 with the UE 10. The one or more memories MEM 12B and the computer program code PROG 12C are configured to cause, with the one or more processors DP 12A, the NN 12 to perform one or more of the operations as described herein. The NN 12 may communicate with another gNB or eNB, or a device such as the NN 13 such as via link 14. Further, the link 11, link 14 and/or any other link may be wired or wireless or both and may implement, e.g., an X2 or Xn interface. Further the link 11 and/or link 14 may be through other network devices such as, but not limited to an NCE/SGW/AMF/UPF device such as the NCE/MME/SGW/UDM/PCF/AMF/SMF 14 of FIG. 7. The NN 12 may perform functionalities of an MME (Mobility Management Entity) or SGW (Serving Gateway), such as a User Plane Functionality, and/or an Access Management functionality for LTE and similar functionality for 5G.

The NN 13 can be associated with a mobility function device such as an AMF or SMF, further the NN 13 may comprise a NR/5G Node B or possibly an evolved NB a base station such as a master or secondary node base station (e.g., for NR or LTE long term evolution) that communicates with devices such as the NN 12 and/or UE 10 and/or the wireless network 1. The NN 13 includes one or more processors DP 13A, one or more memories MEM 13B, one or more network interfaces, and one or more transceivers TRANS 13D interconnected through one or more buses. In accordance with the example embodiments these network interfaces of NN 13 can include X2 and/or Xn interfaces for use to perform the example embodiments of the invention. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the NN 13 to perform one or more of the operations as described herein. The NN 13 may communicate with another mobility function device and/or eNB such as the NN 12 and the UE 10 or any other device using, e.g., link 11 or another link. The Link 14 as shown in FIG. 7 can be used for communication between the NN 12 and the NN 13. These links maybe wired or wireless or both and may implement, e.g., an X2 or Xn interface. Further, as stated above the link 11 and/or link 14 may be through other network devices such as, but not limited to an NCE/MME/SGW device such as the NCE/MME/SGW/UDM/PCF/AMF/SMF 14 of FIG. 7.

The one or more buses of the device of FIG. 7 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D and/or TRANS 10D may be implemented as a remote radio head (RRH), with the other elements of the NN 12 being physically in a different location from the RRH, and these devices can include one or more buses that could be implemented in part as fiber optic cable to connect the other elements of the NN 12 to an RRH.

It is noted that although FIG. 7 shows a network nodes such as NN 12 and NN 13, any of these nodes may can incorporate or be incorporated into an eNodeB or eNB or gNB such as for LTE and NR, and would still be configurable to perform example embodiments of the invention.

Also, it is noted that description herein indicates that “cells” perform functions, but it should be clear that the gNB that forms the cell and/or a user equipment and/or mobility management function device that will perform the functions. In addition, the cell makes up part of a gNB, and there can be multiple cells per gNB.

The wireless network 1 or any network it can represent may or may not include a NCE/MME/SGW/UDM/PCF/AMF/SMF 14 that may include (NCE) network control element functionality, MME (Mobility Management Entity)/SGW (Serving Gateway) functionality, and/or serving gateway (SGW), and/or MME (Mobility Management Entity) and/or SGW (Serving Gateway) functionality, and/or user data management functionality (UDM), and/or PCF (Policy Control) functionality, and/or Access and Mobility Management Function (AMF) functionality, and/or Session Management (SMF) functionality, and/or Authentication Server (AUSF) functionality and which provides connectivity with a further network, such as a telephone network and/or a data communications network (e.g., the Internet), and which is configured to perform any 5G and/or NR operations in addition to or instead of other standard operations at the time of this application. The NCE/MME/SGW/UDM/PCF/AMF/SMF 14 is configurable to perform operations in accordance with example embodiments of the invention in any of an LTE, NR, 5G and/or any standards based communication technologies being performed or discussed at the time of this application. In addition, it is noted that the operations in accordance with example embodiments of the invention, as performed by the NN 12 and/or NN 13, may also be performed at the NCE/MME/SGW/UDM/PCF/AMF/SMF 14.

The NCE/MME/SGW/UDM/PCF/AMF/SMF 14 includes one or more processors DP 14A, one or more memories MEM 14B, and one or more network interfaces (N/W I/F(s)), interconnected through one or more buses coupled with the link 13 and/or 14. In accordance with the example embodiments these network interfaces can include X2 and/or Xn interfaces for use to perform the example embodiments of the invention. The one or more memories MEM 14B include computer program code PROG 14C. The one or more memories MEM 14B and the computer program code PROG 14C are configured to, with the one or more processors DP 14A, cause the NCE/MME/SGW/UDM/PCF/AMF/SMF 14 to perform one or more operations which may be needed to support the operations in accordance with the example embodiments of the invention.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP10, DP12A, DP13A, and/or DP14A and memories MEM 10B, MEM 12B, MEM 13B, and/or MEM 14B, and also such virtualized entities create technical effects.

The computer readable memories MEM 12B, MEM 13B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 12B, MEM 13B, and MEM 14B may be means for performing storage functions. The processors DP10, DP12A, DP13A, and DP14A may be of any type suitable to the local technical environment, and may include one or more of general purpose computers, special purpose computers, microprocessors, digital signal processors (DSPs) and processors based on a multi-core processor architecture, as non-limiting examples. The processors DP10, DP12A, DP13A, and DP14A may be means for performing functions, such as controlling the UE 10, NN 12, NN 13, and other functions as described herein.

In accordance with an example embodiment of the invention as described above there is an apparatus comprising: means for receiving (TRANS 12D and/or TRANS 13D, MEM 12B and/or MEM 13B, PROG 12C and/or PROG 13C, and DP 12A and/or DP 13A as in FIG. 7), by a network node (NN 12 and/or NN 13 as in FIG. 7) receiving, by a network node (NN 12 and/or NN 13 as in FIG. 7) of a communication network (Network 1 as in FIG. 7), from at least one user equipment (UE 10 as in FIG. 7) of a point to multi-point service group an indication of channel quality measured at the at least one user equipment (UE 10 as in FIG. 7), wherein the point to multi-point service group comprises more than one user equipment including the at least one user equipment of the communication network, comprising: means, based on an indication of channel quality measured from at least one user equipment of the group of more than one user equipment, for determining (TRANS 12D and/or TRANS 13D, MEM 12B and/or MEM 13B, PROG 12C and/or PROG 13C, and DP 12A and/or DP 13A as in FIG. 7) the at least one user equipment is not permitted utilization of at least one feedback resource of the point to multi-point service group; and means, based on the determining, for sending (TRANS 12D and/or TRANS 13D, MEM 12B and/or MEM 13B, PROG 12C and/or PROG 13C, and DP 12A and/or DP 13A as in FIG. 7) first information of the determination to the at least one user equipment.

As similarly stated above one main novel step of example embodiments of the invention is that serving DU informs target DU via the CU about the target RS index X/indices X1 . . . Xn that shall be used for PDCCH transmission or PUCCH reception.

In example embodiments of this invention, there is proposed a first method in accordance with example embodiments of the invention (Method 1, building enhancements on top of Option 2, FIG. 3) where the UE and target node of handover synchronizes on the QCL information for PDCCH transmission while ensuring that the target node 1) does not have to reserve radio resources for long time and 2) transmits the PDCCH only when the cell change has been triggered:
When the serving cell (controlled by the serving DU) sends a MAC CE or L1 message to trigger the cell change (indicating to the UE TCI state change to target RS index X for PDCCH reception), it informs the target DU via the CU about the target RS index X that shall be used for PDCCH transmission; and
When receiving this information from the serving cell/DU, the target cell/DU sets the transmit beam according to the RS index and sends the PDCCH transmission correspondingly.

To improve the reliability of PDCCH reception at the UE side, Method 1 can be enhanced with the following embodiments/aspects in accordance with example embodiments of the invention:
Instead of indicating the TCI state change to one RS index X, the serving cell indicates to the UE using MAC CE, the TCI state change to multiple target RS indices X1, X2, . . . , XN for PDCCH reception (in other words it can indicate multiple TCI states). In this case, the UE might receive the PDCCH transmission of the target cell using the QCL of one of the RS indices;
After receiving the MAC CE, UE uses QCL of RS index with strongest L1 beam measurement for PDCCH reception;
The serving DU informs the target DU about set of target RS indices X1, X2, . . . , XN that shall be used for PDCCH transmission:
   In this case, the target DU can send multiple PDCCH transmissions, each using the QCL of one RS index out of the indicated set X1, X2, . . . , XN;
This approach increases the reliability of PDCCH reception as the UE is applying at any time the QCL information of the RS index with strongest measurements for PDCCH reception;
For this approach, RRC signaling may include in one embodiment offset location to be used when using the first uplink grant from one of the target cell PDCCH. Target node deduces the selected beam based on the PUSCH location (derived by the UE using configured offset) where the RRC Reconfiguration Complete message is received, i.e., more details about this can be found below.

In addition, another method 2 (building on top of Option 1, FIG. 2) is proposed, where the target node activates the periodic UL grants for RACH-less HO only when the lower layer handover is triggered by the serving cell. This allows the target node to make overbooking of radio resources.

When receiving a request to prepare a UE configuration in a candidate target cell, the DU provides the configuration of the periodic UL grants, where each UL is QCL with a RS index, but does not reserve radio resources for these UL grants until a notification is received from the serving cell:
In one aspect, the UL grants are active after some time duration T from MAC CE transmission. That is the UE is not allowed to use the UL grant to send RRC Reconfiguration Complete before this time duration has elapsed. This is needed in case the notification is sent by the source cell/DU at the time of triggering the cell change (sending MAC CE). Herein, the time duration T should be long enough to ensure that the target node receives the notification from the serving cell over F1 interfaces and reserve the radio resources for the UL grants;
Otherwise, if the notification to the target DU is sent before the handover decision is taken by the serving DU (much after the preparation of the candidate target cell but slightly before the handover), then the time duration T can be reduced or even skipped entirely. For instance, the serving DU can decide to send the notification when it detects for the first time that the L1 beam measurement of a candidate target cell exceeds that of the serving cell. This alternative may need two different thresholds (triggering condition) to be configured at the serving DU, one for triggering the notification from serving DU to target DU and another for execution of L1/L2 based handover.

An advantage of this approach compared to Method 1 is that the network saves the signalling of PDCCH transmission at the expense of either 1) additional complexity for configuring the timer T in case the notification is sent at the time of cell change or 2) higher radio resource reservation if the notification is sent before the handover.

In addition, it is noted that an approximate value of 8-10 ms can be considered as the average RTT (Round trip time) over the F1 interface.

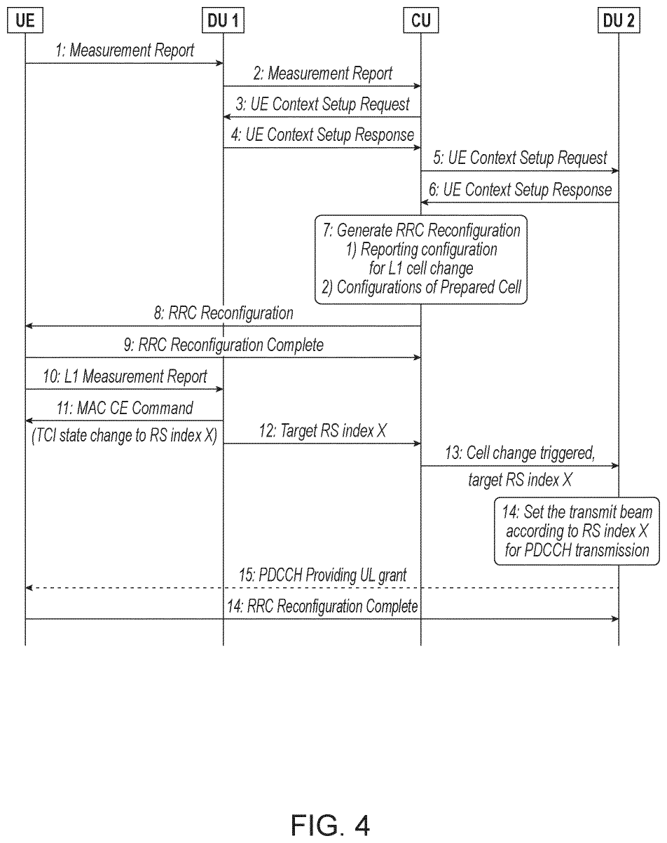

FIG. 4 shows the signaling diagram for Method 1 in accordance with example embodiments of the invention. Some novel aspects in accordance with example embodiments of the invention are shown in steps 11-15 of FIG. 4.

In one embodiment, the notification from DU 1 to DU 2 (step 12/13) may be also delivered using a control PDU which is faster than normal F1 messages as it avoids encoding/decoding at CU.

In another embodiment, step 12 and 13 might be performed earlier than or at the same time with step 11 depending on the F1 interface RTT.

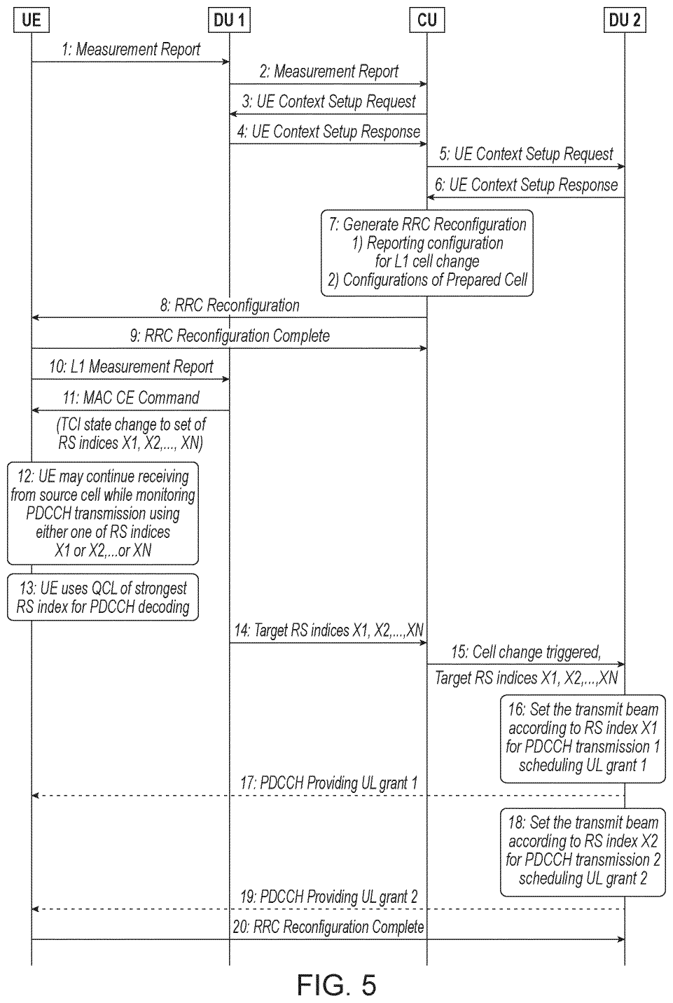

FIG. 5 shows the enhancements on Method 1 to improve the reliability of PDCCH reception at the UE. Some novel aspects in accordance with example embodiments of the invention are shown in steps 11-19 of FIG. 5.

In one embodiment, the PDCCH transmissions of step 17 and 19 of FIG. 5 can be on same or different time/frequency allocation.

In another embodiment, the location of UL grants (in terms of time/frequency radio resources) may depend on the RS index that is QCL with the PDCCH transmission. The offset locations for each RS index may be pre-configured by the target cell as part of step 6 and 8 messages. Herein, the PDCCH transmissions providing UL grant in step 17 and 19 point to the same reference location of the UL grant. The final location of the UL grant is obtained by the UE by adding the corresponding offset location to the reference location.

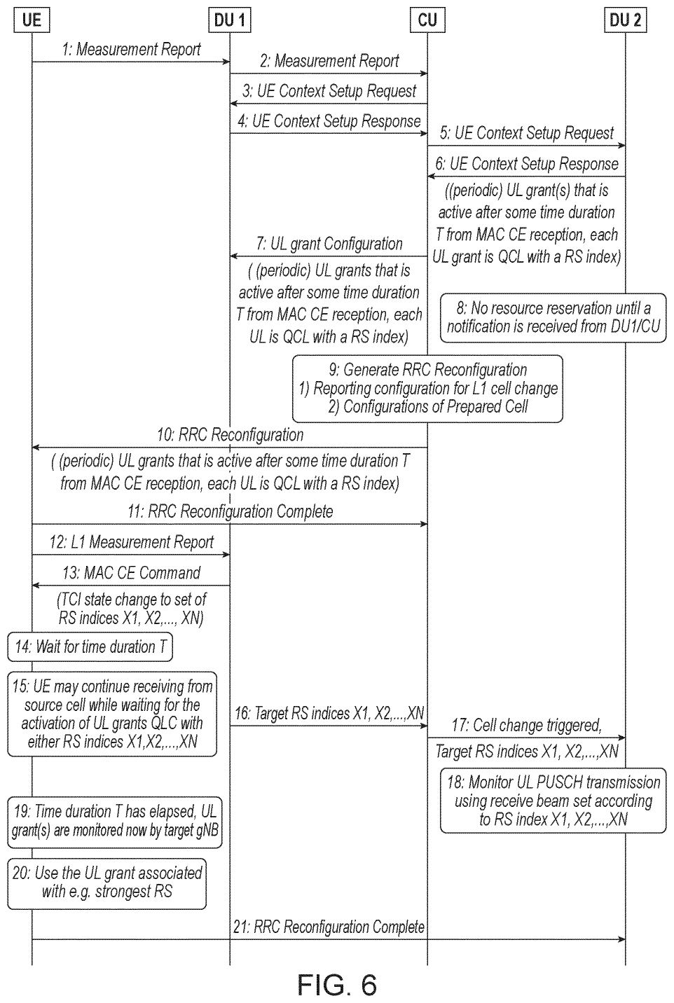

The signaling diagram for Method 2 in accordance with example embodiments of the invention is shown in FIG. 6. Some novel aspects in accordance with example embodiments of the invention are shown in steps 6-10, and 13-20.

In operations of the method 2, when receiving a request to prepare a UE configuration in a candidate target cell, the target DU provides the configuration of the periodic UL grants, where each UL is QCL with a RS index, but does not reserve radio resources for these UL grants until a notification is received from the serving cell. For this a new timer is introduced at the UE, which guarantees, that the UE uses the UL grant to send RRC Reconfiguration Complete not before this time duration has elapsed.

The time duration T must be long enough to ensure that the target node receives the notification from the serving cell over F1 interfaces and reserve the radio resources for the UL grants.

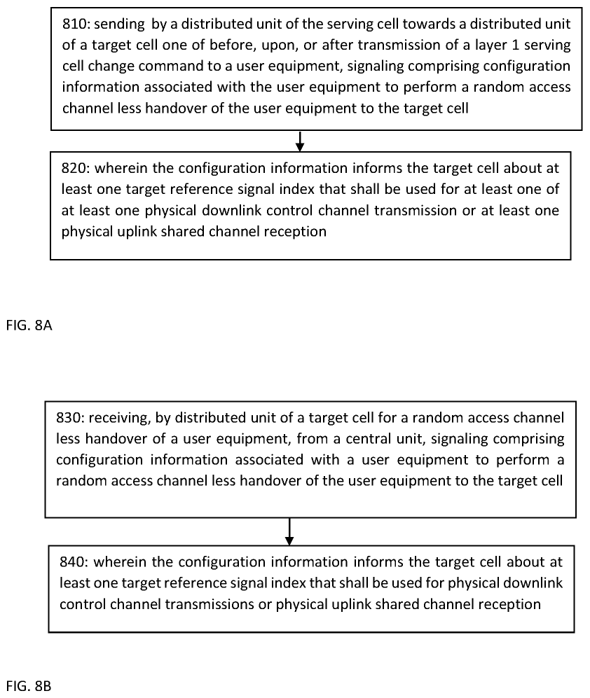

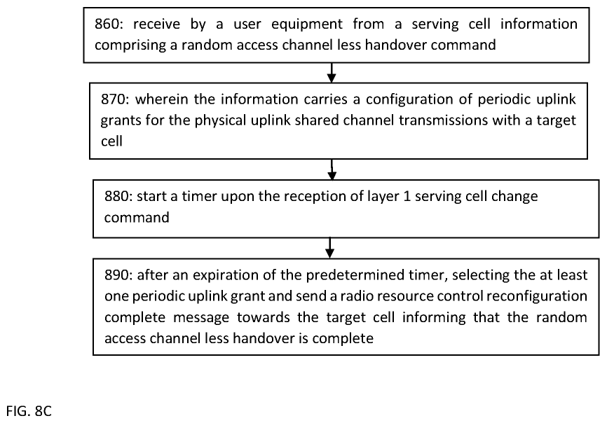

FIG. 8A, FIG. 8B, and FIG. 8C each show a method in accordance with example embodiments of the invention which may be performed by an apparatus.

### Some Operations of Serving Cell Side

FIG. 8A illustrates operations which may be performed by a network device such as, but not limited to, a network node such as NN 12 or NN 13 as in FIG. 7 or an gNB. As shown in step 810 of FIG. 8 there is sending by a distributed unit of the serving cell (supported by NN 12 or NN 13 as in FIG. 7) towards a distributed unit of a target cell (supported by NN 12 or NN 13 as in FIG. 7) one of before, upon, or after transmission of a layer 1 serving cell change command to a user equipment (UE 10 as in FIG. 7), signaling comprising configuration information associated with the user equipment to perform a random access channel less handover of the user equipment to the target cell. Then as shown in step 820 of FIG. 8A wherein the configuration information informs the target cell about at least one target reference signal index that shall be used for at least one of at least one physical downlink control channel transmission or at least one physical uplink shared channel reception.

In accordance with the example embodiments as described in the paragraph above, wherein the serving cell controlled by the distributed unit of the serving cell sends a medium access control-control element or layer 1 message to the user equipment to trigger a cell change indicating to the user equipment a transmission configuration indication state change to at least one target reference signal index X for reception of the at least one physical downlink control channel transmission or transmission on the at least one physical uplink shared channel.

In accordance with the example embodiments as described in the paragraphs above, wherein the serving cell indicates to the user equipment using the medium access control-control element or layer 1 message, the transmission configuration indication state change to multiple target reference signal indices X1, X2, . . . , XN for reception of the at least one physical downlink control channel transmissions or transmission on the at least one physical uplink shared channel.

In accordance with the example embodiments as described in the paragraphs above, wherein the serving cell informs the target distributed unit via the central unit about the at least one target reference signal index X that shall be used for at least one physical downlink control channel transmission or at least one physical uplink shared channel reception.

In accordance with the example embodiments as described in the paragraphs above, wherein the central unit is associated with a distributed unit of the target cell.

In accordance with the example embodiments as described in the paragraphs above, wherein the layer 1 serving cell change command comprises at least one of a medium access control-control element or a layer 1 message.

In accordance with the example embodiments as described in the paragraphs above, wherein the at least one memory and computer program code is configured with the at least one processor to cause the apparatus to: receive from the central unit information comprising at least one configuration of periodic uplink grants for the physical uplink shared channel transmissions, where each uplink grant is quasi co-located with the at least one target reference signal index, wherein the target cell preparation does not involve reserving radio resources for the uplink grants.

A non-transitory computer-readable medium (MEM 12B and/or MEM 13B as in FIG. 7) storing program code (PROG 12C and/or PROG 13C as in FIG. 7), the program code executed by at least one processor (DP 12A and/or DP 13A as in FIG. 7) to perform the operations as at least described in the paragraphs above.

In accordance with an example embodiment of the invention as described above there is an apparatus comprising: means for sending (TRANS 12D and/or TRANS 13D, MEM 12B and/or MEM 13B, PROG 12C and/or PROG 13C, and DP 12A and/or DP 13A as in FIG. 7) by a distributed unit of the serving cell towards a distributed unit of a target cell (NN 12 or NN 13 as in FIG. 7) one of before, upon, or after transmission (TRANS 12D and/or TRANS 13D, MEM 12B and/or MEM 13B, PROG 12C and/or PROG 13C, and DP 12A and/or DP 13A as in FIG. 7) of a layer 1 serving cell change command to a user equipment, signaling comprising configuration information associated with the user equipment to perform a random access channel less handover of the user equipment to the target cell, wherein the configuration information informs the target cell about at least one target reference signal index that shall be used for at least one of at least one physical downlink control channel transmission or at least one physical uplink shared channel reception.

In the example aspect of the invention according to the paragraph above, wherein at least the means for sending comprises a non-transitory computer readable medium [MEM 12B and/or MEM 13B] encoded with a computer program [PROG 12C and/or PROG 13C] executable by at least one processor [DP 12A and/or 13A].

### Some Operations of Target Cell Side

FIG. 8B illustrates operations which may be performed by a network device such as, but not limited to, a network node such as NN 12 or NN 13 as in FIG. 7 or an gNB. As shown in step 830 of FIG. 8B there is receiving (TRANS 12D and/or TRANS 13D, MEM 12B and/or MEM 13B, PROG 12C and/or PROG 13C, and DP 12A and/or DP 13A as in FIG. 7), by distributed unit of a target cell (NN 12 or NN 13 as in FIG. 7) for a random access channel less handover of a user equipment (UE 10 as in FIG. 7), from a central unit (NN 12 or NN 13 as in FIG. 7), signaling comprising configuration information associated with a user equipment to perform a random access channel less handover of the user equipment to the target cell. Then as shown in step 840 of FIG. 8A wherein the configuration information informs the target cell about at least one target reference signal index that shall be used for physical downlink control channel transmissions or physical uplink shared channel reception.

In accordance with the example embodiments as described in the paragraph above, wherein the configuration information comprises the at least one target reference signal index that shall be used for the physical downlink control channel transmissions or the physical uplink shared channel reception.

In accordance with the example embodiments as described in the paragraphs above, wherein the at least one non-transitory memory including the computer program code is configured with the at least one processor to cause the apparatus to: based on the received signaling one of: set a transmit beam according to the at least one target reference signal index and perform the physical downlink control channel transmissions, or set a receive beam according to the at least one target reference signal index and perform the physical uplink shared channel reception.

In accordance with the example embodiments as described in the paragraphs above, wherein based on receiving the signaling comprising configuration information the distributed unit of a target cell sets a transmit beam according to the at least one target reference signal index and performs the physical downlink control channel transmissions correspondingly.

In accordance with the example embodiments as described in the paragraphs above, wherein the target cell selects a beam based on a physical uplink shared channel location where the radio resource control reconfiguration complete message is received.

In accordance with the example embodiments as described in the paragraphs above, wherein the at least one non-transitory memory including the computer program code is configured with the at least one processor to cause the distributed unit of the target cell to: based on receiving a request from the central unit to prepare a user equipment configuration in a candidate target cell, provide configuration of periodic uplink grants to the user equipment.

In accordance with the example embodiments as described in the paragraphs above, wherein each uplink grant is quasi co-located with a reference signal index.

In accordance with the example embodiments as described in the paragraphs above, wherein the at least one memory and computer program code is configured with the at least one processor to cause the apparatus to: configure a timer value controlling the validity of uplink grant after triggering of the layer 1 based serving cell change.

In accordance with the example embodiments as described in the paragraphs above, wherein the configuration of periodic uplink grants is not reserving radio resources for these uplink grants until a notification is received from the serving cell.

In accordance with the example embodiments as described in the paragraphs above, including sending towards the central unit of the network node, information comprising at least one configuration of periodic uplink grants for the physical uplink shared channel transmissions, where each uplink grant is quasi co-located with the at least one target reference signal index, wherein the target cell preparation does not involve reserving radio resources for the uplink grants.

A non-transitory computer-readable medium (MEM 12B and/or MEM 13B as in FIG. 7) storing program code (PROG 12C and/or PROG 13C as in FIG. 7), the program code executed by at least one processor (DP 12A and/or DP 13A as in FIG. 7) to perform the operations as at least described in the paragraphs above.

In accordance with an example embodiment of the invention as described above there is an apparatus comprising: means for receiving (TRANS 12D and/or TRANS 13D, MEM 12B and/or MEM 13B, PROG 12C and/or PROG 13C, and DP 12A and/or DP 13A as in FIG. 7), by distributed unit of a target cell (NN 12 or NN 13 as in FIG. 7) for a random access channel less handover of a user equipment (UE 10 as in FIG. 7), from a central unit of a serving cell (NN 12 or NN 13 as in FIG. 7), signaling comprising configuration information associated with a user equipment to perform a random access channel less handover of the user equipment to the target cell, wherein the configuration information informs the target cell about at least one target reference signal index that shall be used for physical downlink control channel transmissions or physical uplink shared channel reception.

In the example aspect of the invention according to the paragraph above, wherein at least the means for receiving comprises a non-transitory computer readable medium [MEM 12B and/or MEM 13B] encoded with a computer program [PROG 12C and/or PROG 13C] executable by at least one processor [DP 12A and/or 13A].

### Some Operations of User Equipment Side

FIG. 8C illustrates operations which may be performed by a network device such as, but not limited to, a network node such as NN 12 or NN 13 as in FIG. 7 or an gNB. As shown in step 860 of FIG. 8B there is receiving by a user equipment from a serving cell information comprising a random access channel less handover command, As shown in step 870 of FIG. 8C wherein the information carries a configuration of periodic uplink grants for the physical uplink shared channel transmissions with a target cell. As shown in step 880 of FIG. 8C there is starting a timer upon the reception of layer 1 serving cell change command. Then as shown in step 890 of FIG. 8C there is, after an expiration of the predetermined timer, selecting the at least one periodic uplink grant and send a radio resource control reconfiguration complete message towards the target cell informing that the random access channel less handover is complete.

In accordance with the example embodiments as described in the paragraph above, wherein the layer 1 serving cell change command comprises at least one of a medium access control-control element or a layer 1 message.

In accordance with the example embodiments as described in the paragraphs above, wherein the layer 1 serving cell change command comprises at least one least one target reference signal index that shall be used for physical downlink control channel reception or physical uplink shared channel transmission.

In accordance with the example embodiments as described in the paragraphs above, wherein the configuration of periodic uplink grants for the physical uplink shared channel transmissions is quasi co-located with reference signal indexes that are indicated by one of the source or target distributed unit.

In accordance with the example embodiments as described in the paragraphs above, wherein after receiving the at least one of a medium access control-control element or a layer 1 message the user equipment uses the quasi co-located reference signal index with a strongest layer 1 beam measurement for physical downlink control channel reception or physical uplink shared channel transmission.

A non-transitory computer-readable medium (MEM 10B as in FIG. 7 as in FIG. 7) storing program code (PROG 10C as in FIG. 7), the program code executed by at least one processor (DP 10A as in FIG. 7) to perform the operations as at least described in the paragraphs above.

In accordance with an example embodiment of the invention as described above there is an apparatus comprising: means for receiving (TRANS 10D, MEM 10B, PROG 10C, DP 10A) by a user equipment (UE 10 as in FIG. 7) from a serving cell (NN 12 or NN 13 as in FIG. 7) information comprising a random access channel less handover command, wherein the information carries a configuration of periodic uplink grants for the physical downlink control channel transmissions with a target cell. Means for starting a timer upon the reception of layer 1 serving cell change command. Means, after an expiration of the predetermined timer, for selecting (TRANS 10D, MEM 10B, PROG 10C, DP 10A) the at least one periodic uplink grant and send a radio resource control reconfiguration complete message towards the target cell informing that the random access channel less handover is complete.

In the example aspect of the invention according to the paragraph above, wherein at least the means for receiving and selecting comprises a non-transitory computer readable medium [MEM 10B] encoded with a computer program [PROG 10C] executable by at least one processor [DP 10A].

### SUMMARY

With the proposed methods RACH-less HO when applied to L1/2 inter-cell mobility can be clearly improved: Radio resources are reserved short before they are used, PDCCH is transmitted only when the cell change has been triggered and the target DU is allowed to make overbooking of radio resources,
The disadvantages of prior art handling can be removed,
The proposed methods are new, and an inventive step can be seen,
The ideas are connected to standards agreements at the time of this application and will be discussed for the standards agreements when L1/2 centric mobility will be defined,

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.).

Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the invention, there is adequate circuitry for performing at least novel operations as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1. A distributed unit of a serving cell, comprising:
at least one processor; and
at least one non-transitory memory including computer program code, where the at least one non-transitory memory and the computer program code are configured, with the at least one processor, to cause the distributed unit of the serving cell to at least:
send towards a distributed unit of a target cell one of before, upon, or after transmission of a layer 1 serving cell change command to a user equipment, signaling comprising configuration information associated with the user equipment to perform a random access channel less handover of the user equipment to the target cell,
wherein the configuration information informs the target cell about at least one target reference signal index that shall be used for at least one of at least one physical downlink control channel transmission or at least one physical uplink shared channel reception.

2. The distributed unit of the serving cell of claim 1, wherein the at least one non-transitory memory and the computer program code are configured with the at least one processor to cause the distributed unit of the serving cell to:
send a medium access control-control element or layer 1 message to the user equipment to trigger a cell change indicating to the user equipment a transmission configuration indication state change to at least one target reference signal index X for reception of the at least one physical downlink control channel transmission or transmission on the at least one physical uplink shared channel.

3. The distributed unit of the serving cell of claim 2, wherein the at least one non-transitory memory and the computer program code are configured with the at least one processor to cause the distributed unit of the serving cell to:
indicate to the user equipment using the medium access control-control element or layer 1 message, the transmission configuration indication state change to multiple target reference signal indices X1, X2, . . . , XN for reception of the at least one physical downlink control channel transmissions or transmission on the at least one physical uplink shared channel.

4. The distributed unit of the serving cell of claim 1, wherein the at least one non-transitory memory and the computer program code are configured with the at least one processor to cause the distributed unit of the serving cell to:
inform the distributed unit of the target cell via a central unit about the at least one target reference signal index X that shall be used for at least one physical downlink control channel transmission or at least one physical uplink shared channel reception.

5. (canceled)

6. The distributed unit of the serving cell of claim 1, wherein the layer 1 serving cell change command comprises at least one of a medium access control-control element or a layer 1 message.

7. The distributed unit of the serving cell of claim 1, wherein the at least one memory and the computer program code are configured with the at least one processor to cause the distributed unit of the serving cell to:
receive from a central unit information comprising at least one configuration of periodic uplink grants for the physical uplink shared channel transmissions, where each uplink grant is quasi co-located with the at least one target reference signal index.

8. A distributed unit of a target cell, comprising:
at least one processor; and
at least one non-transitory memory including computer program code, where the at least one non-transitory memory and the computer program code are configured, with the at least one processor, to cause the distributed unit of the target cell to at least:
receive for a random access channel less handover of a user equipment, from a central unit, signaling comprising configuration information associated with a user equipment to perform a random access channel less handover of the user equipment to the target cell,
wherein the configuration information informs the target cell about at least one target reference signal index that shall be used for physical downlink control channel transmissions or physical uplink shared channel reception.

9. The distributed unit of the target cell of claim 8, wherein the configuration information comprises the at least one target reference signal index that shall be used for the physical downlink control channel transmissions or the physical uplink shared channel reception.

10. The distributed unit of the target cell of claim 8, wherein the at least one non-transitory memory and the computer program code are configured with the at least one processor to cause the distributed unit of the target cell to:
based on the received signaling one of:
set a transmit beam according to the at least one target reference signal index and
perform the physical downlink control channel transmissions, or
set a receive beam according to the at least one target reference signal index and
perform the physical uplink shared channel reception.

11. The distributed unit of the target cell of claim 8, wherein the at least one non-transitory memory and the computer program code are configured with the at least one processor to cause the distributed unit of the target cell to:
select a beam based on a physical uplink shared channel location where a radio resource control reconfiguration complete message is received.

12. The distributed unit of the target cell of claim 8, wherein the at least one non-transitory memory and the computer program code are configured with the at least one processor to cause the distributed unit of the target cell to:
based on receiving a request from the central unit to prepare a user equipment configuration in a candidate target cell, provide configuration of periodic uplink grants to the user equipment.

13. The distributed unit of the target cell of claim 12, wherein each uplink grant is quasi co-located with a reference signal index.

14. The distributed unit of the target cell of claim 8, wherein the at least one memory and the computer program code are configured with the at least one processor to cause the distributed unit of the target cell to:
configure a timer value controlling the validity of uplink grant after triggering of a layer 1 based serving cell change.

15. The distributed unit of the target cell of claim 8, wherein a configuration of periodic uplink grants is not reserving radio resources for these uplink grants until a notification is received from a serving cell.

16. The distributed unit of the target cell of claim 8, wherein the at least one memory and the computer program code are configured with the at least one processor to cause the distributed unit of the target cell to:
send towards the central unit information comprising at least one configuration of periodic uplink grants for the physical uplink shared channel transmissions, where each uplink grant is quasi co-located with the at least one target reference signal index, wherein a target cell preparation does not involve reserving radio resources for the uplink grants.

17. A user equipment, comprising:
at least one processor; and
at least one non-transitory memory including computer program code, where the at least one non-transitory memory and the computer program code are configured, with the at least one processor, to cause the user equipment to at least:
receive from a serving cell information comprising a random access channel less handover command, wherein the information carries a configuration of at least one periodic uplink grant for the physical uplink shared channel transmissions with a target cell; and
start a timer upon the reception of layer 1 serving cell change command; and
after an expiration of the predetermined timer, select the at least one periodic uplink grant and send a radio resource control reconfiguration complete message towards the target cell informing that the random access channel less handover is complete.

18. The user equipment of claim 17, wherein the layer 1 serving cell change command comprises at least one of a medium access control-control element or a layer 1 message.

19. The user equipment of claim 17, wherein the layer 1 serving cell change command comprises at least one least one target reference signal index that shall be used for physical downlink control channel reception or physical uplink shared channel transmission.

20. The user equipment of claim 18, wherein the configuration of periodic uplink grants for the physical uplink shared channel transmissions is quasi co-located with reference signal indexes that are indicated by one of a distributed unit of the serving cell or a distributed unit of the target cell.

21. The user equipment of claim 18, wherein the at least one memory and the computer program code are configured with the at least one processor to cause the user equipment to:
after receiving the at least one of a medium access control-control element or a layer 1 message, use a quasi co-located reference signal index with a strongest layer 1 beam measurement for physical downlink control channel reception or physical uplink shared channel transmission.
